(19) United States
(12) Patent Application Publication
(10) Pub. No.: US 2012/0268371 A1
(43) Pub. Date: Oct. 25, 2012

(54) Image Projection Device

(75) Inventor: Koji Takahashi, Osaka (JP)

(73) Assignee: PANASONIC CORPORATION, Osaka (JP)

(21) Appl. No.: 13/451,564

(22) Filed: Apr. 20, 2012

(30) Foreign Application Priority Data
Apr. 20, 2011 (JP) 2011-093740

(51) Int. Cl. G06F 3/033

(52) U.S. Cl. 345/157

(57) ABSTRACT

A menu of commands is displayed on a screen by using visible light, and command frames are simultaneously displayed on the screen at the same positions using invisible light so as to enclose the commands. When invisible light is emitted from an indicating rod over a command intended to be operated, and when the light emitted from the indicating rod is detected within a command frame, an image projection device executes the command corresponding to the command frame. As a result, menu operation can be conducted easily and immediately without the need to perform a calibration even when the positional relationship between the projection device and a screen has been shifted.

### BACKGROUND OF THE INVENTION

1. Field of the Invention

The present invention relates to image projection devices that enlarge and project, on screens, image data from a personal computer or the like, and that include means for executing, by the selecting with an indicating rod of a menu item displayed on a screen, a command corresponding to the menu item.

2. Description of the Background Art

There have existed systems for giving presentations through projecting image data from personal computers onto screens using projectors. Projectors and systems using such projectors available in recent years have functions that enable, by using a laser pointer utilizing infrared light or an indicating rod including an infrared light emitting element on a tip thereof, plotting of a trajectory and interactive operation with a mouse cursor.

Examples of such products include a projection-type display device that detects, by using an imaging device for infrared light, a screen position pointed and indicated with a laser pointer utilizing infrared light, and that depicts, using a projector, a cursor at the position that has been pointed and indicated.

On the other hand, as a mechanism for controlling or calibrating display devices, one mechanism is to have multiple commands viewable upon opening a menu of a display device, such that execution of a necessary control or calibration can be conducted by selecting and executing a necessary command from among the multiple commands.

In recent years, there have been demands for a method that allows the selecting and executing of a command in the menu in a more easy and intuitive manner. For example, there have been demands for a method or a device for directly pointing, selecting, and executing a command by using an indicating rod or the like.

In order to select a command in a menu, one proposed device employs a method that allows execution of an intended command by using an indicating rod, furnished with a light-emitting component that emits light of a specific wavelength, to point at the command within a list of commands displayed in a menu.

### SUMMARY OF THE INVENTION

One aspect of the present invention is an image projection device for projecting images on a screen in accordance with an image signal. The image projection device includes: a first display element configured to modulate visible light into an image, and transmit or reflect the modulated visible light; a second display element configured to modulate, when the first display element depicts an image indicating a command, invisible light into a graphic pattern superimposed on an area of the screen where the command is depicted, and transmit or reflect the modulated invisible light; combining optics configured to combine the visible light that has been transmitted through or reflected from the first display element with the invisible light that has been transmitted through or reflected from the second display element; projection optics configured to project, on the screen, composite light combined by the combining optics; imaging means configured to capture the invisible light included in the composite light projected onto the screen; an indicator configured to emit invisible light capturable by the imaging means; and command execution means configured to execute the command in a situation in which the imaging means captures the graphic pattern superimposed on the area where the command is depicted and simultaneously captures the invisible light emitted by the indicator, and in which the invisible light emitted by the indicator is located inside the graphic pattern.

### BRIEF DESCRIPTION OF THE DRAWINGS

FIG. 1 is a schematic diagram of a system including a projection device of the present invention;

FIG. 2 shows one example of an image of a menu configuration;

FIG. 3 shows an image of command frames in the case with the menu of FIG. 2;

FIG. 4 shows an image obtained by combining visible light and infrared light in the case with the menu of FIG. 2;

FIG. 5 shows one example of a moment when a selection has been made with an indicating rod in the case with the menu of FIG. 2;

FIG. 6 shows image information obtained by capturing an image of FIG. 5 and processing the image by a detection section;

FIG. 7 is a flowchart for describing an operation starting from an identification of an image to an execution of a command;

FIG. 8 shows one example of an image of a menu configuration in a case where a numerical value bar is set as a command; and

FIG. 9 shows an image for describing barycentric coordinates of a point of light emission in the case with the menu of FIG. 8.

### DESCRIPTION OF THE PREFERRED EMBODIMENTS

### Embodiment

One embodiment of the present invention will be described in the following with reference to the drawings.

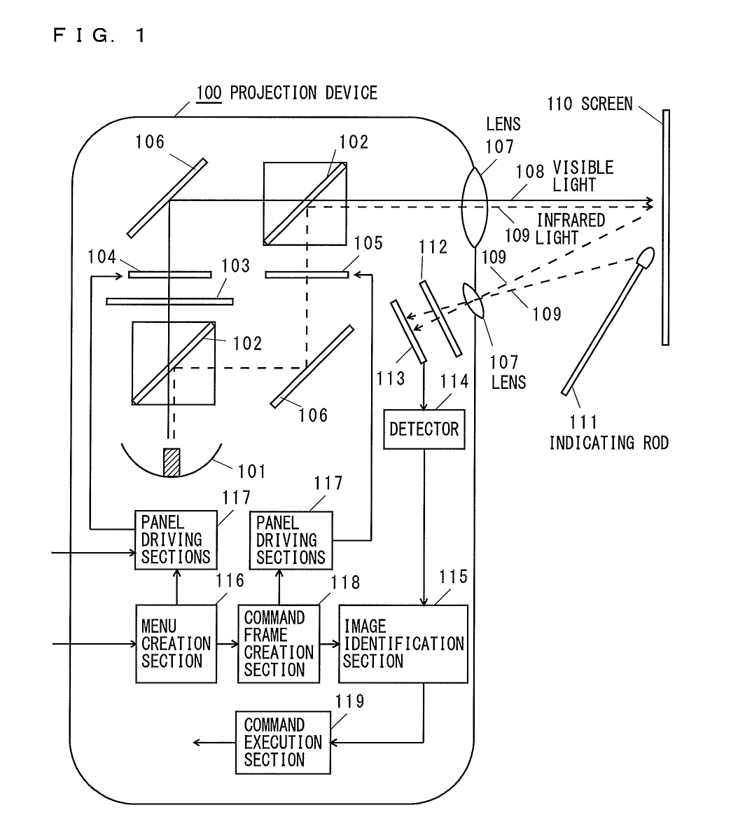

FIG. 1 shows a schematic configuration of a system including a projection device which is one embodiment of the present invention.

In FIG. 1, a reference character of 100 represents a projection device showing a schematic configuration of the present invention. The projection device 100 projects an image on a screen in accordance with an inputted image signal. An internal configuration of the projection device 100 will be described next. With regard to the reference characters: 101 represents a light source lamp including a high pressure mercury lamp or the like; 102 represents infrared-light reflecting plates that have a property of only reflecting light having infrared wavelengths and allowing light having other wavelengths to pass through; 103 represents a visible-light transmission filter that has a property of only allowing light having visible wavelengths to pass through; 104 represents a liquid crystal panel provided specially for visible light; 105 represents a liquid crystal panel provided specially for infrared light; 106 represents a total-reflection plate for reflecting visible light and a total-reflection plate for reflecting infrared light; 107 represents a lens for enlarging and projecting an image onto a screen and a lens for collecting light that has been projected on the screen; 108 represents, in a solid line, a passage route of light that has visible wavelengths, which is visible with the human eyes; 109 represents, in a dotted line, a passage route of light that has infrared wavelengths, which is not visible with human eyes; and 110 represents a screen for displaying an image projected from the projection device.

Among the light emitted from the light source lamp 101, infrared light is reflected by the infrared-light reflecting plate 102, and light other than infrared light is allowed to be transmitted. The transmitted light passes through the visible-light transmission filter 103 so as to become the visible light 108 consisting only of light having visible wavelengths. The visible light 108 is modulated into a visible-light image by the visible-light liquid crystal panel 104. The visible-light image is sent to the lens 107 via the total-reflection plate 106 and through the infrared-light reflecting plate 102. On the other hand, light emitted from the light source lamp 101 and reflected by the infrared-light reflecting plate 102 becomes the infrared light 109 consisting only of light having infrared wavelengths. The infrared light is reflected by the total-reflection plate, modulated into an infrared-light image by the infrared-light liquid crystal panel 105. The infrared-light image is reflected by the infrared-light reflecting plate 102, combined with the visible-light image, and sent to the lens 107. The visible-light image and the infrared-light image are enlarged and projected on the screen by the lens 107, such that they are superimposed and projected at the same position.

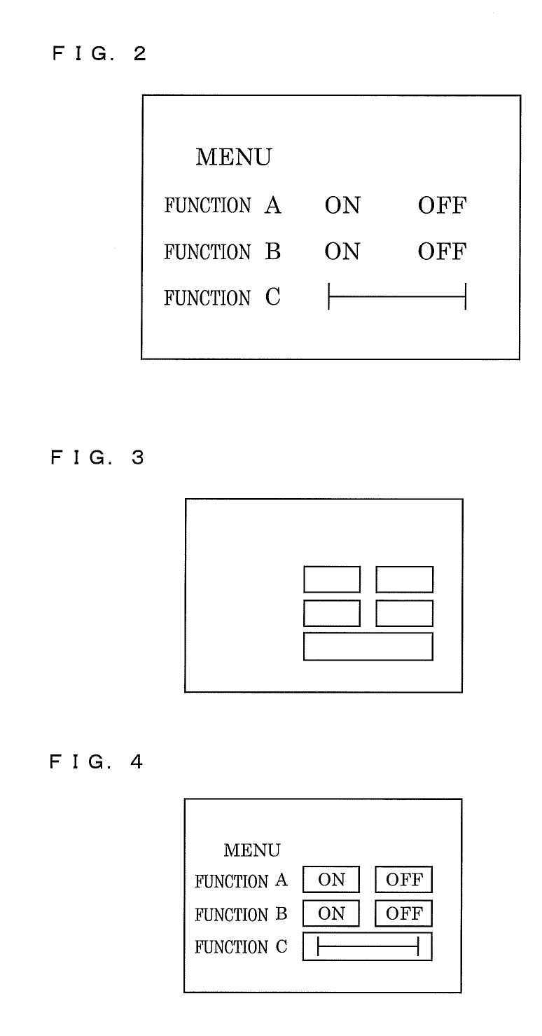

FIG. 2 shows one example of a configuration of a menu image for controlling the projection device.

The menu image shown in FIG. 2 has a menu configuration in which function A includes two commands of “ON” and “OFF,” function B includes two commands of “ON” and “OFF,” and function C includes an adjustment bar capable of setting a continuous numerical value in a variable manner. The operation with such menu configuration will be described later. Images of the menu of FIG. 2 are all formed with visible light.

FIG. 3 shows an image including command frames in the case with the menu configuration of FIG. 2.

The command frames in FIG. 3 are created with respect to the menu of FIG. 2 as frames enclosing respective character display areas of the commands, and the multiple frames are formed as a single image. Images of the command frames in FIG. 3 are all formed with infrared light.

FIG. 4 shows an image depicted by superimposing the menu image formed with visible light and the command frames formed with infrared light. The image shown in FIG. 4 is projected and displayed on the screen, and an operation with regard to that will be described later.

With regard to the reference characters in FIG. 1, 116 represents a menu creation section, 117 represents panel driving sections for depicting an image on a liquid crystal panel, and 118 represents a command frame creation section for creating a frame and converting the frame into an image so as to enclose a command included in the menu.

Next, an operation will be described regarding a case where, for example, the image of the menu of FIG. 2 is created by the menu creation section 116 in FIG. 1. The menu image in FIG. 2 is created by the menu creation section 116, and depicted on the visible-light liquid crystal panel 104 via one of the panel driving sections 117. On the other hand, associated with the menu image in FIG. 2, the images of the command frames in FIG. 3 are created by the command frame creation section 118, and depicted on the infrared-light liquid crystal panel 105 via the other panel driving section 117. Images depicted by the visible-light liquid crystal panel 104 and the infrared-light liquid crystal panel 105 are combined by the infrared-light reflecting plate 102. The image shown in FIG. 4 is the resulting combined image. At the end, the image in FIG. 4 is enlarged and projected on the screen 110 through the lens 107. The image projected on the screen becomes an image obtained by combining visible light and infrared light as shown in FIG. 4. With regard to the combined image, the image that is actually visible with human eyes is only the image shown in FIG. 2, and the image shown in FIG. 3 is not visible with human eyes.

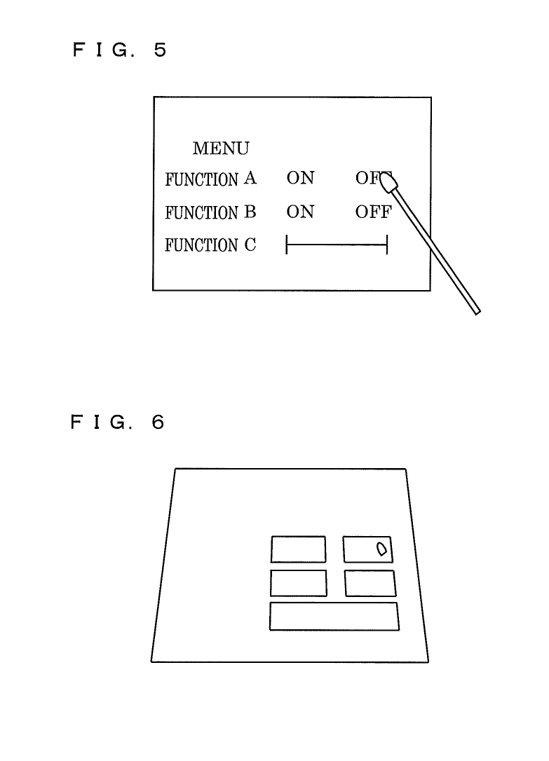

FIG. 5 shows a situation where a position in the menu image displayed on the screen has been pointed using an indicating rod.

In FIG. 5, items in function A includes commands of “ON” and “OFF,” and described next is an example in which an operation of pointing “OFF” has been conducted using the indicating rod.

With regard to the reference characters in FIG. 1: 111 represents an indicating rod capable of emitting infrared light from a tip thereof; 112 represents an infrared-light transmission filter that has a property of only allowing light having infrared wavelengths to pass through; 113 represents a two dimensional imaging element typified by CCD cameras and CMOS cameras; 114 represents a detector for removing noise and unnecessary image signals from image signals obtained from the two dimensional imaging element, and extracting a command frame and an infrared emission image; 115 represents an image identification section for comparing an image created by the command frame creation section with an image obtained from the detector, identifying an image of a command frame, and detecting an emission of infrared light; and 119 represents a command execution section for issuing a command to conduct a control based on a result calculated by the image identification section. It should be noted that the indicating rod 111 may be in any form as long as it includes a light emitter for emitting light having wavelengths that can pass through the infrared-light transmission filter 112, and has a function as an indicator for pointing a position on the screen using the emitted light.

In FIG. 1, an area for item “OFF” of function A in the menu image displayed on the screen 110 in FIG. 2 is pointed and indicated by the indicating rod 111 as shown in FIG. 5. When infrared light is emitted from the tip of the indicating rod 111, light from the image displayed on the screen and the light emitted from the indicating rod are collected by the lens 107 as subjects to be captured. Among the captured light, only the light having infrared wavelengths is extracted by the infrared-light transmission filter 112, captured by the two dimensional imaging element 113, and converted into image signals. In order to remove noise and unnecessary image signals from the obtained image signals, the detector 114 extracts images having at least a certain level of brightness, and then, extracts image signals of the command frame and image signals of the light emitted from the indicating rod by observing continuity in numerous two dimensional images that are extracted during a course of time. Specifically, images having continuity are detected as the command frame, whereas images that do not have continuity during a course of time are detected as the light emitted from the indicating rod and outputted as image signals. The image signals outputted from the detector 114 form an image shown in FIG. 6. It should be noted that, since the two dimensional imaging element 113 in FIG. 1 captures an image from a diagonal direction with respect to the screen 110, the image signals obtained from the detector 114 form a trapezoid-wise distorted image as shown in FIG. 6.

The image identification section 115 can identify which command frame corresponds to which command, by comparing the image signals in FIG. 6 obtained from the detector 114 with the image in FIG. 3 created by the command frame creation section 118, and calculating a correlation between the two images. Furthermore, when the detector 114 detects the light emitted from the indicating rod and when the image identification section 115 determines that the light emitted from the indicating rod is located inside a command frame, the command execution section 119 executes a command corresponding to the command frame. In the case with the above described example, since it is determined that the emission of light is located within a frame of the command “OFF” for function A, the command execution section 119 executes the command for turning “OFF” function A. Since the image identification section 115 determines the position of the light emitted from the indicating rod by using, as a standard, the command frame projected with infrared light, the image identification section 115 can conduct the determination with high precision without being influenced by other projection contents and characters included in the menu image which are projected with visible light.

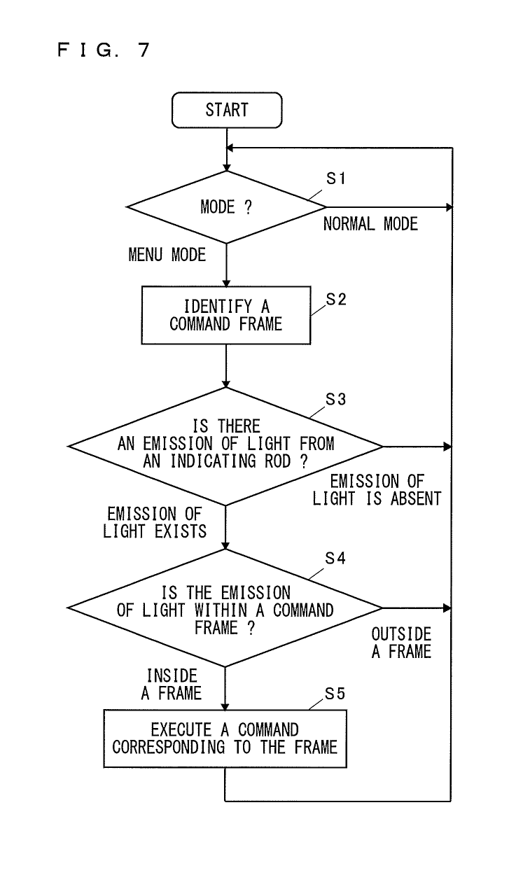

For the present embodiment having the above described configuration, an operation starting from the image identification to the execution of the command based on the detection result is described in the following using FIG. 7.

The operation of the present embodiment is configured to operate in a menu mode (S1). Switching between the menu mode (in which the menu image is displayed) and a normal mode (in which the menu image is not displayed) is conducted when, for example, the projection device 100 receives a specific operation by the user. When the menu of FIG. 2 is used as one example, the command frames in FIG. 3 are depicted; however, the detector 114 obtains the image in FIG. 6. The image identification section 115 compares FIG. 3 and FIG. 6, and identifies which frame among the multiple frames in FIG. 6 corresponds to a frame for “ON” of function A, a frame for “OFF” of function A, a frame for “ON” of function B, a frame for “OFF” of function B, or a frame for the numerical value bar of function C (S2). Then, waiting continues until the detector 114 detects light emitted from the indicating rod (S3). Next, waiting continues until the detected light emitted by the indicating rod is located within a command frame (S4). When light is emitted inside a command frame by the indicating rod, the command execution section 119 executes a command corresponding to the command frame identified at S2 (S5).

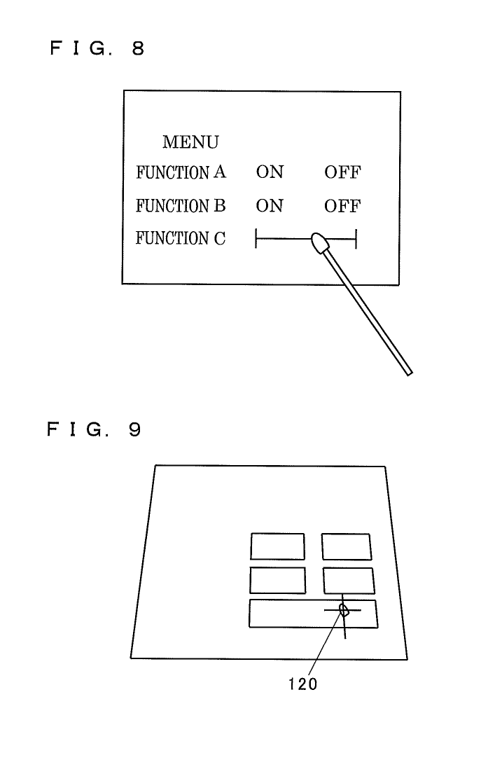

An operation performed when the numerical value bar which is the command for function C in FIG. 2 is operated is described as follows. FIG. 8 shows a moment when the numerical value bar of function C is pointed by the indicating rod. FIG. 9 shows an image signal obtain from the detector in the case of FIG. 8. In FIG. 9, a reference character of 120 represents coordinates of a barycenter calculated from the detected image of the light emitted from the indicating rod.

In the case with the menu of FIG. 8, the detector 114 obtains the image in FIG. 9. The frame is identified by the image identification section 115 as being a frame corresponding to the frame for the numerical value bar of function C in FIG. 9. Since it known in advance that the identified command frame is the numerical value bar, when light is emitted from the indicating rod inside the command frame, the image identification section 115 calculates the barycentric coordinates 120 of the infrared light emitted from the indicating rod. A numerical value to be configured is calculated from relative coordinates between the barycentric coordinates 120 of the infrared emission and the command frame for the numerical value bar, and is notified to the command execution section 119. The command execution section 119 executes a command of configuring function C so as to be set with the numerical value.

The projection device of the present embodiment is characterized by the above described configuration and operation. When the projection device is, for example, carried, moved, and installed at another location, a positional relationship between the projection device 100 and the screen 110 changes. In other words, this is equivalent to changing the positional relationship between the two dimensional imaging element 113, and the visible-light liquid crystal panel 104 and the infrared-light liquid crystal panel 105 with respect to the screen 110. With conventional technologies, in order to correct the positional relationship every time the positional relationship changes, it has been necessary to conduct a process of calibration or a process of providing beforehand a light emitting section on the screen as a standard. However, with the configuration of the present embodiment, since a method for determining a command to be executed utilizes the detection of light emitted inside a command frame by the indicating rod, it is not necessary to correct the positional relationship even when the positional relationship is changed.

In the present embodiment, when light emitted from the indicating rod is determined to be inside a frame of a command, the command corresponding to the frame is executed. Therefore, regardless of the positional relationship between the projection device and the screen even immediately after when the projection device has been carried and moved or immediately after when the screen has been installed, a command pointed by the indicating rod can be immediately executed after installation, without conducting a calibration beforehand or conducting a process of providing beforehand a light emitting section on the screen as a standard.

In the present embodiment, although the liquid crystal panel is used in the projection device as an example, the liquid crystal panel is merely one example of a projection technology for the present invention, and the present invention can be achieved using other projection technologies such as digital micro-mirror devices (DMD), reflective liquid crystal elements (LCOS), and the like.

Furthermore, in the present embodiment, although an example has been described in which a single piece of each the visible-light liquid crystal panel and the infrared-light liquid crystal panel is included, the present invention can be achieved when multiple pieces of each of the liquid crystal panels are included.

In the present embodiment, an example has been described in which infrared light is used as the invisible light. Usage of infrared light is suitable in terms of designing and manufacturing, since visible light and infrared light can be acquired from the same light source lamp 101, and since these lights can be easily separated using the infrared-light reflecting plate. However, the present invention can also be achieved when light other than infrared light is used as the invisible light, such as ultraviolet ray, far-infrared ray, etc., having other wavelengths.

The embodiments described herein are suitable for usage and production of image projection devices and the like, and can do so without requiring calibration every time the projection devices are carried and moved.

What is claimed is:

1. An image projection device for projecting images on a screen in accordance with an image signal, the image projection device comprising:
a first display element configured to modulate visible light into an image, and transmit or reflect the modulated visible light;
a second display element configured to modulate, when the first display element depicts an image indicating a command, invisible light into a graphic pattern superimposed on an area of the screen where the command is depicted, and transmit or reflect the modulated invisible light;
combining optics configured to combine the visible light that has been transmitted through or reflected from the first display element with the invisible light that has been transmitted through or reflected from the second display element;
projection optics configured to project, on the screen, composite light combined by the combining optics;
imaging means configured to capture the invisible light included in the composite light projected onto the screen;
an indicator configured to emit invisible light capturable by the imaging means; and
command execution means configured to execute the command in a situation in which the imaging means captures the graphic pattern superimposed on the area where the command is depicted and simultaneously captures the invisible light emitted by the indicator, and in which the invisible light emitted by the indicator is located inside the graphic pattern.

2. The image projection device according to claim 1, wherein the invisible light is infrared light.
